(19) United States
(12) Patent Application Publication
(10) Pub. No.: US 2025/0362936 A1
(43) Pub. Date: Nov. 27, 2025

(54) SESSION-BASED FLOATING NAVIGATION FUNCTION

(71) Applicant: Truist Bank, Charlotte, NC (US)

(72) Inventors: Denese Michelle Doby, Atlanta, GA (US); Jacob Silas Moser, Atlanta, GA (US); Serafina Bui-Tran Kitchen, Buford, GA (US); Chuong Dinh, Atlanta, GA (US); Gabriel Malaki Sheridan, Iron Station, NC (US); Kathryn Leigh Borneman, Suwanee, GA (US)

(73) Assignee: Truist Bank, Charlotte, NC (US)

(21) Appl. No.: 18/670,808

(22) Filed: May 22, 2024

(51) Int. Cl. G06F 9/451; G06F 3/04842

(52) U.S. Cl. CPC G06F 9/451; G06F 3/04842

(57) ABSTRACT

Disclosed are systems and methods that display a primary graphical user interface and a session-based floating navigation function integrated with the primary graphical user interface. When the primary graphical user interface is replaced with a second graphical user interface in response to user inputs, the floating navigation function is also integrated and displayed with the second graphical user interface. The floating navigation function points to a memory location associated with the primary graphical user interface such that the primary graphical user interface is displayed when the floating navigation function integrated with the second interface is selected by the end user.

### TECHNICAL FIELD AND BACKGROUND

The present invention relates generally to the field of computer graphical user interfaces (“GUI,” “user interface,” or “interface”), and more particularly, to a floating navigation function that navigates an end user to a previously viewed graphical user interface.

Conventional systems for navigating to a previously viewed graphical user interface utilize either a “back” button that sequentially displays the last prior viewed graphical user interface, or alternatively, a “bookmark” function that navigates to a specific, pre-designated user interface. In some circumstances, such where an end user navigates through a non-linear path, conventional system are not able to display certain previously viewed graphical user interfaces. In other cases, a graphical user interface may be a generalized “home screen” that does not display data previously viewed by an end user in a repeatable fashion. Even when an end user is able to locate a previous user interface, the navigation path can be complex and time consuming.

It is, therefore, an object of the present invention to provide systems and methods that generate a session-based, floating navigation function that allows end users to reliably navigate to a previously viewed user interface even if the end user navigates in a non-linear fashion, or if the previously viewed user interface is a generalized user interface that does not display data in a static, consistent manner. The systems allow end users to navigate to a desired graphical user interface and to accomplish such navigation more efficiently with a reduced volume of inputs.

### SUMMARY

Disclosed are systems and methods that implement a session-based floating navigation function that include a computer with includes at least one processor and a memory device that stores data and executable code. When the code is executed, the processor assembles a primary graphical user interface that includes a plurality of control components and end user data. The system stores the primary user interface to memory. The system generates a floating navigation function that points to the primary user interface location in the memory device. The floating navigation function is represented by an icon integrated with (i.e., displayed on) the primary user interface.

As the end user navigates through the system, the primary user interface is replaced with a second interface in response to the end user selecting a first control component, such as a hyperlink or button. The floating navigation function is also integrated with the second interface so that it remains visible to the end user. In this manner, the navigation function is “floating” so that it travels with the end user as the end user navigates the provider system through different user interfaces. When the floating navigation function is selected by the end user, the system displays the primary interface.

In one embodiment, the primary interface includes a top-level container, a sub-level container that displays supplemental end user data, and a second navigation control component. The sub-level container is displayed when the end user selects the second navigation control component, and the system stores the sub-level container to the memory device. The sub-level container is later displayed as part of the primary interface when the floating navigation function integrated with the second interface is selected by the end user.

The primary interface and the secondary interface can be displayed on an end user computing device by an internet browser software application or by a mobile software application integrated with the end user computing device.

In some embodiments, the primary interface is displayed in response to end user inputs to an end user computing device. For instance, the end user may be required to enter a search parameters or identifying information to display the primary interface. In that case, the end user inputs are stored to the memory device with the primary interface. When the floating navigation function integrated with the second interface is selected by the end user, the end user inputs are automatically re-entered to the end user computing device. This allows the primary interface to be once again displayed without the end user having to manually re-enter a series of inputs.

The primary interface can include a “mark-floating-navigation control component,” such as a button, that when selected, generates the floating navigation function. In other embodiments, the system can display a prompt, such as a popup window, before a user navigates away from the primary interface. The prompt can ask the user whether the user wants to mark the primary interface with the floating navigation function.

In yet other embodiments, the system generates the primary interface using end user settings that are stored to a profile data file. When the primary interface is marked with the floating navigation function, the profile data file is stored to the memory device with the primary interface. Thus, when the floating navigation function integrated with the second interface is selected by the end user, the profile data file is used to display the primary interface. This ensures the primary interface continues to be displayed according to user specified settings.

### BRIEF DESCRIPTION OF THE DRAWINGS

Features, aspects, and advantages of the present invention are better understood when the following detailed description of the invention is read with reference to the accompanying figures, in which:

FIG. 1 is an example system diagram according to one embodiment.

FIG. 2 is an example graphical user interface.

FIG. 3 is an example graphical user interface showing the floating navigation function.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The example embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the terms “enterprise” or “provider” generally describes a person or business that provides goods or services as well as access to proprietary software that generates one or more graphical user interfaces that facilitate access to the goods or services. The term “user” is used interchangeably with the terms end user, customer or consumer and represents individuals who operate computing devices that use the systems and methods disclosed in this application for viewing and navigating graphical user interfaces. The provider may render services or provide goods to the end user as part of one or more transactions or as part of an ongoing customer relationship that utilizes the technology described in this application for enhancing efficient navigation of user interfaces that are used as part of providing goods and services.

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

### System Level Description

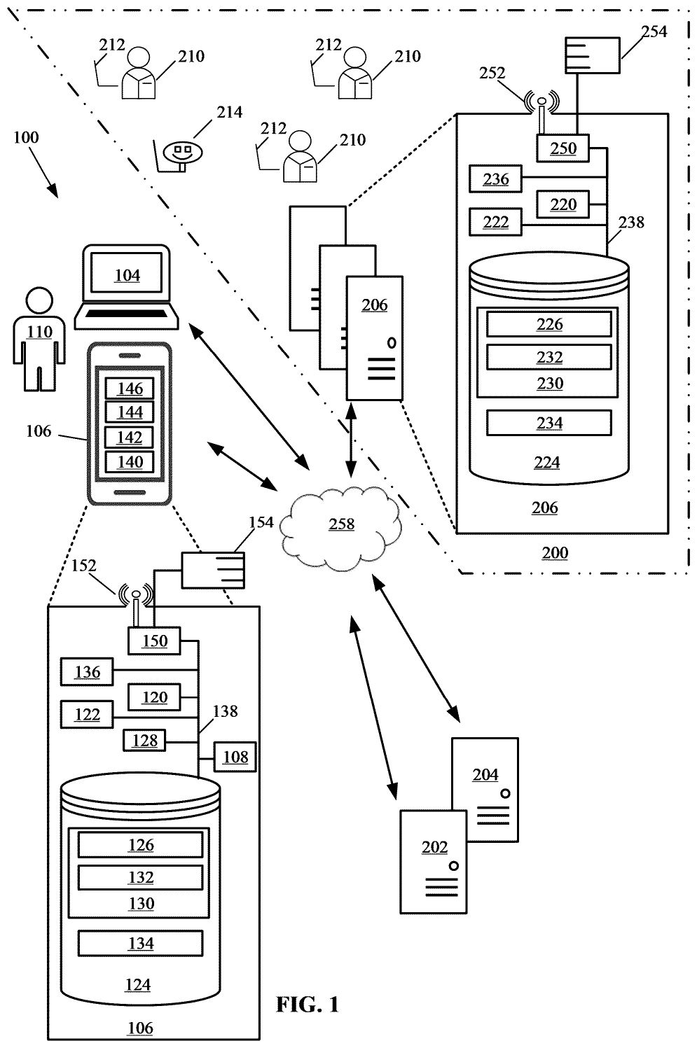

As shown in FIG. 1, a hardware system 100 configuration according to one embodiment generally includes a user 110 that benefits through use of services and products offered by a provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, business entities, government entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configures to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the provider system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The integrated software applications also typically provide a graphical user interface (“GUI”) on the user computing device display screen 140 that allows the user 110 to utilize and interact with the user computing device. Example GUI display screens are depicted in the attached figures. The GUI display screens may include control functions for displaying information and accepting inputs from users, such as text boxes, data fields, hyperlinks, pull down menus, check boxes, radio buttons, and the like. One of ordinary skill in the art will appreciate that the example functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 & 106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 act on behalf of the provider, such as customer service representatives, advisors, managers, and sales team members.

Human agents 210 utilize agent computing devices 212 to interface with the provider system 200. The agent computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the agent computing devices 212. As used herein, the general term “end user computing device” can be used to refer to either the agent computing device 212 or the user 110 depending on whether the agent (as an employee or affiliate of the provider) or the user (as a customer or consumer) is utilizing the disclosed systems and methods to segment, parse, filter, analyze, and display content data.

Human agents 210 interact with users 110 or other agents 212 by phone, via an instant messaging software application, or by email. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, account balances, and transaction histories, files downloaded or received from other devices, and other data items required or related to the applications or programs 230 & 232.

The network 258 provides wireless or wired communications among the components of the hardware system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated hardware system 100.

External systems 270 and 272 represent any number and variety of data sources, users, consumers, customers, enterprises, and groups of any size. In at least one example, the external systems 270 and 272 represent remote terminal utilized by the enterprise system 200 in serving users 110. In another example, the external systems 270 and 272 represent electronic systems for processing payment transactions. The system may also utilize software applications that function using external resources 270 and 272 available through a third-party provider, such as a Software as a Service (“SasS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing system 206, or user computing device 104 & 106.

### Interfacing With a Provider System

A provider can develop, distribute, and maintain one or more proprietary software applications and systems that end users utilize to access a provider's system by navigating a series of graphical user interfaces displayed on an end user computing device. End user computing devices access the provider system using an Internet browser software application to communicate with a webserver or other network computing devices maintained by the provider. The provider system transmits executable software code and other data that, when processed by the end user computing device, renders a website on a display screen of the end user computing device.

Alternatively, end user computing devices access the provider system through a software application installed on the end user computing device that displays one or more graphical user interfaces rendered in part using data received from the provider system. An example is a provider mobile software application that is downloaded to the end user computing device and configured to render a series of graphical user interfaces on a mobile device, such as a cellular smart phone or tablet computer.

With respect to website graphical user interfaces, to access the provider's system, the end user computing device first transmits an interface instruction request to a webserver or network device maintained on the provider system. The interface instruction request can include: (i) an Internet Protocol (“IP”) address for the end user computing device; (ii) navigation data; and (iii) system configuration data. In response to the interface instruction request, the webserver returns interface assembly instructions and a digital cookie that is stored to the end user computing device and used to track functions and activities performed by the end user computing device.

The interface assembly instructions are implemented as executable software code that is processed by the end user computing device to generate a graphical user interface that is displayed on the end user computing device screen. The interface assembly instructions determine various elements of a graphical user interface and how those elements are displayed. Elements of the graphical user interface include containers, such as frames and panels, that partition the graphical user interface into smaller sections that display numerical data, text, or that incorporate control functions that accept end user inputs (e.g., radio buttons, push buttons, pull-down menus, hyperlinks, and the like). The interface assembly instructions also determine the layout, existence, and number of various components, such as labels, text input fields, buttons, collapsible pull-down menus, toolbars, and hyperlinks, among others.

Containers can be top-level containers that incorporate one or more sub-level containers, such as a large frame or panel that includes multiple small panels within the larger frame or panel. In other cases, the top-level container is displayed as a separate user interface from the sub-level container where the top-level container is a “main” or “primary” user interface, and end users select a navigation control component to display a sub-level container as a secondary user interface of the same type. As an example, the top-level container might be a first Product Display user interface that displays end user data such as five of ten products owned by an end user, and the sub-level container is a second Product Display user interface that displays supplemental end user data such as the next five products owned by the end user. The sub-level container could also be implemented as an expanded version of the top-level container, such as where the top-level container is a user interface that shows five of ten end user profile attributes, and the sub-level container is displayed by selecting an “expand” control component to show supplemental end user data that includes all ten end user attributes in a single graphical user interface of an expanded length. Thus, the top-level container could be a condensed or summary view, and the sub-level container is displayed as an expanded or full view.

The interface assembly instructions can be implemented with software code formats such as hypertext markup language (“html”), Cascading Style Sheets (“CSS”), ACTIVEX, and JAVASCRIPT, among other suitable software languages and settings files. Cascading Style Sheets are instructions that control various aspects of a user interface, such as color, font type, text size, the spacing between elements on the user interface, how elements are positioned and laid out, the background images, background colors, and variations in the display for different computing device types, screen sizes, and operating systems. The Cascading Style Sheets are “cascading” in the sense that a setting applied to a parent or top-level element will also apply to all sub-level or child elements. For instance, if the color of body text is set to “blue,” then headings, paragraphs, and other text elements within the body will also be set to the same color.

The interface assembly instructions can include software code that initiates the execution of local software application packages stored to an end user computing device. For instance, the interface assembly instructions can generate a graphical user interface that displays a control component input function that launches a separate portable document format (“PDF”) viewer, that displays an icon integrated with or displayed on top of an Internet browser software application, or that opens a separate “popup” window to accept a username and password.

The interface assembly instructions can include general instructions that are sent to all system users as well as end user specific data and instructions. End user specific instructions include settings that apply to specific users. End user settings are user inputs that define the type of data displayed and the manner in which such data is displayed, such as preferences and customization settings for the various software applications utilized by the end user. Settings can be stored to a profile data file stored to a provider system or an end user computing device that is accessed by the interface assembly instructions. The profile data file can include instructions for the operating system used by the end user computing device that establish parameters such as specifying the icons, control components (i.e., input functions), shortcuts, and bookmarks utilized by a particular end user. The end user profile further includes other customization information including, without limitation, color schemes, font settings, background images, and graphical user interface layout information that determines the position, size, and arrangement of containers, control components, and other elements of a graphical user interface.

The profile data file can be stored to a provider system and downloaded at the commencement of communication session between the end user computing device and the provider system. The profile data file is utilized by software applications running on the end user computing device to customize the display of graphical user interfaces. The end user profile can be modified by, for example, by adding a floating navigation function or other feature. Such modifications are reported back to the provider system either as they occur, or at the end of a communication session with the provider system. This allows the user profile and user files located on the end user computing device to be synchronized with that stored in the End User Database (discussed below).

End user specific data can include content data that applies to a given end user, such as an end user identification (e.g., username or number), contact information (e.g., an email address), end user product identification data (e.g., account numbers), and end user resource availability data (e.g., an account balance). End user specific data is generally transmitted from a provider system and displayed on the user computing device within the framework of a graphical user interface. To illustrate, the interface assembly instructions may include software code that establishes a frame in a graphical user interface having fields of “account name” and “account balance.” The interface assembly instructions can also include software code that instructs the end use computing device to request product identification data and resource availability data from the provider system. The product identification is displayed in the account name field while the resource availability data is displayed in the account balance field.

In some embodiments, the navigation data and system configuration data are utilized by the provider system to generate the interface assembly instructions. For instance, the system configuration data may indicate that the end user computing device is utilizing a particular Internet browser or mobile software application to communicate with the provider system. The provider system then generates interface assembly instructions that are compatible with, and readable by, the particular Internet browser or mobile software application. As another example, if the navigation data indicate the end user computing device previously visited a provider webpage, the provider display data can include instructions for displaying a customized message on the end user computing device, such as “Welcome back Patrick!”

Navigation data transmitted by the end user computing device generally includes information relating to prior functions and activities performed by the end user computing device. Examples of navigation data include: (i) navigation history data (i.e., identifiers like website names and IP addresses showing websites previously access by the end user computing device); (ii) redirect data (i.e., data indicating whether the end user computing device selected a third-party universal resource locator (“URL”) link that redirected to the provider web server); and (iii) search history data (e.g., data showing keyword searches in a search engine, like Google® or Bing®, performed by the end user computing device).

Navigation history data allows a provider to determine whether an end user computing device was previously used to visit particular websites, including the provider's own website. The navigation history data further indicates whether the end user computing device accesses relevant third-party websites, such as provider websites that offer products and services similar to those offered by a provider. The navigation history data includes, without limitation: (i) URL data identifying a hyperlink link to the website; (ii) website identification data, such as a title of a visited website; (iii) website IP address data indicating an IP address for a web server associated with a visited website; and (iv) time stamp data indicating the date and time when a website was accessed.

Redirect data may indicate whether the end user computing device selected a hyperlink or control component that redirected the end user computing device to a different part of the provider system. For instance, a user viewing an account webpage might use a “search” feature or a “help” feature to determine more information about how to perform a particular function, such as view historical product data. After conducting a search, the end user might select a hyperlink displayed within an Internet browser in response to the search or help query. Selecting the link causes the end user computing device to navigate to a webpage hosted by a third-party or hosted by a different provider server that effectively operates as a third-party source, such as navigating from retail banking user interface to a technical support user interface that operates independently. The redirect data includes information identifying the domain that was the source of the redirect as well as the domain that hosts the interface to which the end user computing device was redirected.

Search history data is generated when an end user computing device runs a query within a search engine. The search history data can include, without limitation: (i) a search engine identification indicating the search engine that was utilized; (ii) search parameter data indicating the alphanumeric strings or operators used as part of a search query (e.g., Boolean operators such as “AND” or “OR” or functional operators, like “insite” used to search the contents of a specific website); and (iii) time stamp data indicating the date and time a search was performed.

The end user computing device may also transmit system configuration data to the provider system that is used to evaluate a user or authenticate the end user computing device. System configuration data can include, without limitation: (i) a unique identification for the end user computing device (e.g., a media access control (“MAC”) address hardcoded into a communication subsystem of the end user computing device); (ii) a MAC address for the local network of an end user computing device (e.g., a router MAC address); (iii) copies of key system files that are unlikely to change between instances when a user accesses the provider system; and (iv) a list of software applications running or installed on the end user computing device.

The end user computing device optionally authenticates to the provider system if, for instance, the end user has an existing electronic account with the provider. The end user computing device navigates to a login interface and enters user security data, such as a user name and password. The end user selects a submit function on an user interface display screen to transmit an user authentication request message that includes the user security data to the provider system. In some embodiments, the end user security data and user authentication request message can further include elements of the system configuration data that are used to authenticate the user, such as an end user computing device identification or Internet protocol address.

The provider system performs a verification analysis to verify the identity of the end user or the end user computing device. The verification analysis can compare the received user security data to stored user security data to determine whether the security data sets match. In this manner, the provider system determines whether a correct user name, password, device identification, or other security data is received. The provider system generates an authentication notification message. The authentication notification message includes a verification flag indicating whether the verification passed or failed and a reason for any failed authentication, such as an unrecognized user name, password, or end user computing device identification.

The user authentication request message can also include system configuration data used to perform the verification process. As one example, the provider system might store an end user computing device MAC address to an End User Database record as part of the end user data. Upon receipt of an user authentication request message that includes a MAC address, the provider system compares the received MAC address against stored MAC address data associated with the end user data. In this manner, the end user computing device can also be authenticated to the provider system. If the received and stored MAC addresses do not match, the provider system returns an authentication decision message indicating the verification failed because the end user computing device could not be authenticated. The provider system can then prompt the user to verifying whether the consumer is using a new device to login to the provider system, and if so, being the process of registering a new device to the provider's system.

When a user initiates a provider-user interaction by communicating with a provider through written electronic communications or VoIP, the communications originate from an end user computing device, such as a personal computer, a smart phone, or tablet computing device. In that instance, the provider system receives incoming initialization data that can include a device IP address for the end user computing device, an email address, or other account identification. The provider system utilizes the initialization data to transmit a query to the provider's internal End User Database to determine if an existing database record matches initialization data. In this manner, either the incoming telephone number, the end user computing device IP address, email address, or other end user data is used to determine an identification for the end user and whether the end user is a current or former provider customer.

The provider stores a wide variety of information relating to end users within an End User Database. The End User Database comprises database records that correspond to individual end users. The end user database records include, without limitation: (i) a user identification; (ii) user contact data, including a mailing address or a geographic region where the user resides (e.g., a zip code, city, state); (iii) user source data, such as user telephone number data, user device IP Address data, an email address, or a social media account name; (iv) user demographic data, including the gender and age of the end user; (v) one or more product identifications that indicate the accounts or products currently held by a user (e.g., a checking account, a home loan, brokerage account, etc.); (vi) user resource availability data (e.g., balances for various product types or account types associated with, or held by, a user); (vii) average resource availability data that indicates the average value of products or account balances maintained by the user over a given time period (e.g., an average monthly balance for an account held by the user); (viii) transaction data that includes data and information relating to user transactions, such as payment amounts, dates when a transaction occurred, data that identifies other parties to the transaction (i.e., a payment recipient), and information identifying a category of expenditures for the transaction (i.e., groceries, transportation, etc.); (ix) average resource utilization volume data indicating the average number of transactions an end user conducts using a given product over a given time period (e.g., the number of resource expenditures per month for a given account or accounts); (x) user online activity data indicating user attempts to log into the provider system to access user accounts or other activities performed by users online or through a dedicated mobile device software application; or (xi) system configuration data.

### Floating Navigation Function

End users navigating a provider system using graphical user interfaces may take a non-linear navigation path or navigate to a graphical user interface that does not consistently display the same content. In either circumstance, the system might not permit an end user computing device to return to a previously visited graphical user interface without entering a multitude of inputs (e.g., search parameters or identification data) or without navigating through a long sequence of graphical user interfaces. To overcome this disadvantage, the system can incorporate a session-based floating navigation function that permits end users to navigate to a previously viewed graphical user interface.

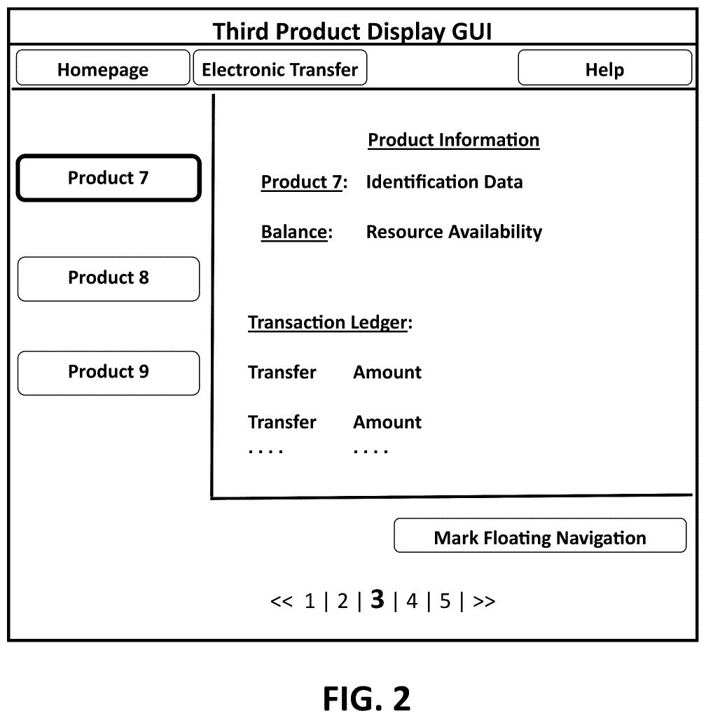

To illustrate with a simplified example, end users might have ten products with a provider, but the primary “Product Display” graphical user interface shows end user data representing only three products. The primary Product-Display graphical user interface might be configured with a series of secondary graphical user interfaces or sub-level containers that display supplemental end user data representing products four through ten. These secondary graphical user interfaces or sub-level containers might be accessible by selecting a control component such as a hyperlink or navigation function, like a series of arrows and numbers designating the secondary graphical user interfaces. An example is illustrated in FIG. 2 where secondary graphical user interfaces are accessed by selecting the “<<” or “>>” characters adjacent to the user interface number—e.g., <<1|2|3|4|5>>.

When an end user computing device navigates away from a primary or secondary Product Display graphical user interface and attempts to later return to any of the Product Display graphical user interfaces, the system may, by default, return the user computing device to the primary Product Display graphical user interface. Thus, a user computing device that was displaying one of the secondary Product Display graphical user interface could not expediently return to the same secondary Product Display graphical user interface without once again navigating through the primary Product Display graphical user interface. This could be a function of the interface assembly instructions that are set to “refresh” the Product Display graphical user interface with each new navigation instance by first rendering the primary Product Display graphical user interface before requesting updated data from the provider system regarding the product identifications and resource availability data associated with the particular end user.

As another example, even if the interface assembly instructions did not consistently refresh the Product Display graphical user interface, an end user computing device might navigate through a first, second, third, and fourth Product Display graphical user interface. If the end user selects a “back” navigation function to return to the third Product Display graphical user interface, and then the end user navigates away from the third Product Display graphical user interface to an Electronic Transfer graphical user interface, the end user computing device has taken a non-linear navigation path. Thus, selecting the “back” navigation function will not return the end user computing device to the fourth Product Display graphical user interface. While the foregoing is a simplified example, for elongated navigation paths having dozens of graphical user interface views, end users commonly have difficultly returning to a desired graphical user interface.

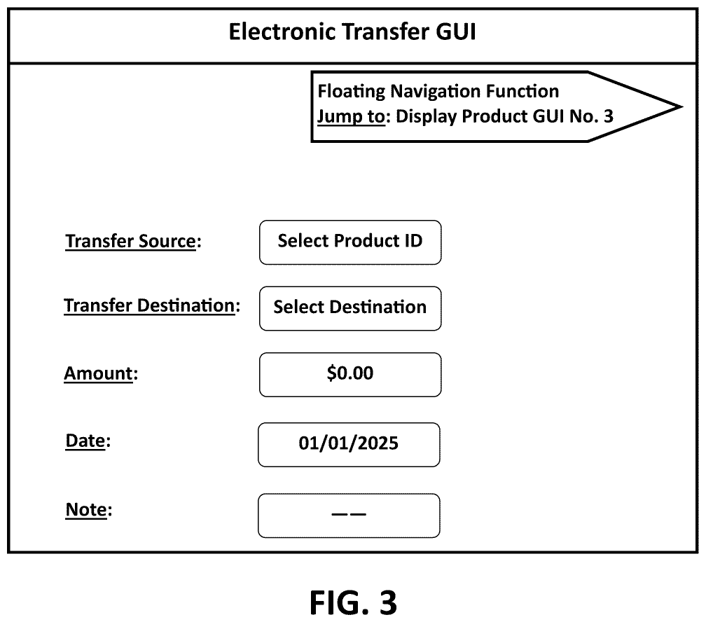

In yet another example, some graphical user interfaces can only be accessed by first inputting specific data. An Electronic Transfer graphical user interface, such as the user interface shown in FIG. 3, could require end user computing devices to enter product identifications for the recipients and sources of an electronic transfer as well as dates, narrative descriptions, and resource transfer amounts. If the end user computing device is required to navigate away from the Electronic Transfer graphical user interface—for instance, to look up a product identification number or a required payment amount—the end user computing device may not be able to return to the Electronic Transfer graphical user interface without reentering the required data and information. In other instance, a graphical user interface include control components that change the display of content data, such as functions that expand a menu tree or show additional data. Such inputs would also have to be re-entered for an end user to locate particular content data.

The system can implement a session-based floating navigation function that stores the interface assembly instructions as well as prior end user inputs that permit an end user computing device to return to any previously viewed graphical user interface. The floating navigation function can be implemented by a software application running on either the end user computing device or a provider system. The floating navigation function allows the software to store in memory not only the interface assembly instructions for a primary or secondary graphical user interface or top-level and sub-level container, but also to store end user selections such as navigation inputs—e.g., selection of the “<<” or “>>” functions—and data input into a graphical user interface—e.g., data input into an Electronic Transfer graphical user interface. The software is further configured to store to memory any end user data or end user settings that might be required to later navigate to and display a particular graphical user interface, such as storing an end user identification, product identifications, resource availability data, or setting from a profile data file (e.g., user interface layout information, font size, color, among many other settings). In this manner, the system can automatically re-enter user inputs and end user data to recreate a series of steps or a navigation path to return to a particular graphical user interface.

The floating navigation function can be configured to “point to” or “return” to a particular graphical user interface in response to end user computing device inputs that mark particular user interfaces. FIG. 2 includes a “Mark Floating Navigation” button that is used to point the floating navigation function to the third Product Display graphical user interface. Alternatively, the system can be configured to automatically point a floating navigation function to certain graphical user interfaces based on end user settings stored to a profile data file or based on provider system settings. In other embodiments, the interface assembly instructions can be configured to output a prompt on the end user computing device requesting an end user input selection as to whether the floating navigation function should point to a given graphical user interface prior to navigating away from the given graphical user interface.

The floating navigation function can be displayed as a graphical icon or text that is integrated with the current graphical user interface being displayed by an end user computing device. An example icon is shown in FIG. 3 and marked with the label “Floating Navigation Function.” The floating navigation icon can incorporate text that provides information about the graphical user interface to which the floating navigation function is currently pointing. Once the floating navigation function is set to point to a specific previously viewed graphical user interface, the floating navigation function is “floating” in that the function continues to display on each successive graphical user interface that is accessed by an end user computing device. That is, the floating navigation function appears to be integrated with each graphical user interface. The floating navigation function remains until the function is disabled or until an end user computing device terminates a communication session with a provider system.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system that implements a floating navigation function comprising a computer that includes at least one processor and a memory device storing data and executable code that, when executed, causes the at least one processor to:
(a) assemble a primary interface comprising a plurality of control components and end user data;
(b) store the primary interface to the memory device;
(c) generate a floating navigation function that comprises an icon pointing to the primary interface location in the memory device, wherein the floating navigation function is integrated with the primary interface;
(d) replace the primary interface with a second interface in response to an end user selecting a first control component, wherein the floating navigation function is integrated with the second interface; and
(e) display the primary interface when the floating navigation function integrated with the second interface is selected by the end user.

2. The system for implementing a floating navigation function of claim 1, wherein:
(a) the primary interface further comprises (i) a top-level container; (ii) a sub-level container that comprises supplemental end user data, and (iii) a second navigation control component;
(b) the executable code further causes the processor to
(i) display the sub-level container when the end user selects the second navigation control component,
(ii) store the sub-level container to the memory device when the end user selects the second navigation control component, and
(iii) display the sub-level container as part of the primary interface when the floating navigation function integrated with the second interface is selected by the end user.

3. The system for implementing a floating navigation function of claim 1, wherein the primary interface and the secondary interface are displayed on an end user computing device by an internet browser software application.

4. The system for implementing a floating navigation function of claim 1, wherein the primary interface and the secondary interface are displayed on an end user computing device by a mobile software application.

5. The system for implementing a floating navigation function of claim 1, wherein:
(a) the primary interface is displayed in response to end user inputs to an end user computing device;
(b) the end user inputs are stored to the memory device with the primary interface; and
(c) when the floating navigation function integrated with the second interface is selected by the end user, the end user inputs are automatically re-entered to the end user computing device.

6. The system for implementing a floating navigation function of claim 1, wherein:
(a) the primary interface comprises a mark-floating-navigation control component; and

7. The system for implementing a floating navigation function of claim 1, wherein the executable code is executed, the processor further:
(a) displays a prompt that includes a mark-floating-navigation control component prior to the end user selecting the first control component; and
(b) the floating navigation function is generated in response to an end user selecting the mark-floating-navigation control component.

8. The system for implementing a floating navigation function of claim 1, wherein:
(a) the primary interface is assembled using instructions from a profile data file;
(b) the profile data file is stored to the memory device with the primary interface; and
(c) when the floating navigation function integrated with the second interface is selected by the end user, the profile data file is used to display the primary interface.

9. A system that implements a floating navigation function comprising a computer that includes at least one processor and a memory device storing data and executable code that, when executed, causes the at least one processor to:
(a) transmit primary interface assembly instructions and end user data to an end user computing device in response to an interface request received from the end user computing device, wherein the interface assembly instructions comprise executable software code that, when executed by the end user computing device, cause the end user computing device to display a primary interface that comprises a plurality of control components and the end user data;
(b) store the interface assembly instructions and end user data to a temporary storage location on the memory device;
(c) generate a floating navigation function that comprises an icon pointing to the interface assembly instructions and end user data temporary storage location, wherein the floating navigation function is integrated with the primary interface;
(d) replace the primary interface with a second interface in response to an end user selecting a first control component, wherein the floating navigation function is integrated with the second interface; and
(e) display the primary interface when the floating navigation function integrated with the second interface is selected by the end user.

10. The system for implementing a floating navigation function of claim 9, wherein:
(a) the primary interface further comprises (i) a top-level container; (ii) a sub-level container that comprises supplemental end user data, and (iii) a second navigation control component;
(b) the executable code further causes the processor to
(i) display the sub-level container when the end user selects the second navigation control component,
(ii) store the sub-level container to the memory device with the interface assembly instructions when the end user selects the second navigation control component, and
(iii) display the sub-level container as part of the primary interface when the floating navigation function integrated with the second interface is selected by the end user.

11. The system for implementing a floating navigation function of claim 9, wherein the primary interface and the secondary interface are displayed on the end user computing device by an internet browser software application.

12. The system for implementing a floating navigation function of claim 9, wherein the primary interface and the secondary interface are displayed on the end user computing device by a mobile software application.

13. The system for implementing a floating navigation function of claim 9, wherein:
(a) the primary interface is displayed in response to end user inputs to the end user computing device;
(b) the end user inputs are stored to the temporary storage location with the interface assembly instructions; and
(c) when the floating navigation function integrated with the second interface is selected by the end user, the end user inputs are automatically re-entered to the end user computing device.

14. The system for implementing a floating navigation function of claim 9, wherein:
(a) the primary interface comprises a mark-floating-navigation control component; and

15. The system for implementing a floating navigation function of claim 9, wherein:
(a) the primary interface is assembled using instructions from a profile data file;
(b) the profile data file is stored to the temporary storage location with the interface assembly instructions; and
(c) when the floating navigation function integrated with the second interface is selected by the end user, the profile data file is used to display the primary interface.

16. A system that implements a floating navigation function comprising a computer that includes at least one processor and a memory device storing data and executable code that, when executed, causes the at least one processor to:
(a) execute interface assembly instructions stored to display a primary interface that comprises a plurality of control components and end user data;
(b) store the interface assembly instructions to the memory device;
(c) generate a floating navigation function that points to the interface assembly instructions temporary storage location, wherein the floating navigation function is displayed concurrently with the primary interface;
(d) replace the primary interface with a second interface in response to an end user selecting a first control component, wherein the floating navigation function is displayed concurrently with the second interface; and
(e) display the primary interface when the floating navigation function integrated with the second interface is selected by the end user by executing the interface assembly instructions stored to the temporary storage location.

17. The system for implementing a floating navigation function of claim 16, wherein the primary interface and the secondary interface are displayed on the end user computing device by an internet browser software application.

18. The system for implementing a floating navigation function of claim 16, wherein the primary interface and the secondary interface are displayed on the end user computing device by a mobile software application.

19. The system for implementing a floating navigation function of claim 16, wherein:
(a) the primary interface is displayed in response to end user inputs to the end user computing device;
(b) the end user inputs are stored to the memory device with the interface assembly instructions; and
(c) when the floating navigation function integrated with the second interface is selected by the end user, the end user inputs are automatically re-entered to the end user computing device.

20. The system for implementing a floating navigation function of claim 16, wherein:
(a) the primary interface comprises a mark-floating-navigation control component; and
(b) the floating navigation function is generated in response to an end user selecting the mark-floating-navigation control component.
